(19) United States
(12) Patent Application Publication
(10) Pub. No.: US 2026/0322417 A1
(43) Pub. Date: Oct. 15, 2026

(54) RADIO FREQUENCY INTEGRATED CIRCUIT AND OPERATING METHOD THEREOF, AND ELECTRONIC DEVICE

(71) Applicant: SAMSUNG ELECTRONICS CO., LTD., Suwon-si (KR)

(72) Inventors: Jeongkyun WOO, Suwon-si (KR); Jongmin JEONG, Suwon-si (KR); Jongsoo LEE, Suwon-si (KR); Sangsung LEE, Suwon-si (KR); Chanhong PARK, Suwon-si (KR); Gwangchun PARK, Suwon-si (KR); Hojung KANG, Suwon-si (KR)

(73) Assignee: SAMSUNG ELECTRONICS CO., LTD., Suwon-si (KR)

(21) Appl. No.: 19/644,288

(22) Filed: Apr. 10, 2026

(30) Foreign Application Priority Data
Apr. 15, 2025 (KR) 10-2025-0049147
Jul. 22, 2025 (KR) 10-2025-0099326

(51) Int. Cl. H04B 1/40

(52) U.S. Cl. CPC H04B 1/40

(57) ABSTRACT

A radio frequency integrated circuit (RFIC) including a plurality of radio frequency (RF) chains includes a first RF chain and a second RF chain differing from the first RF chain, and a target circuit included in the first RF chain is selectively connected to at least one shared capacitor included in the second RF chain by using a plurality of switch elements.

### CROSS-REFERENCE TO RELATED APPLICATIONS

This application is based on and claims priority under 35 U.S.C. § 119 to Korean Patent Application Nos. 10-2025-0049147, filed on Apr. 15, 2025, and 10-2025-0099326, filed on Jul. 22, 2025, in the Korean Intellectual Property Office, the disclosures of which are incorporated by reference herein in their entireties.

### BACKGROUND

The disclosure relates to a radio frequency integrated circuit for reducing a chip area of the radio frequency integrated circuit to lower manufacturing costs, an operating method thereof, and an electronic device.

Recently, as wireless communication technology advances rapidly, the significance of radio frequency integrated circuit (RFIC) technology for implementing a high-performance wireless transmission and reception function is increasing in various mobile communication terminals and Internet of things (IoT) devices. Therefore, research is being actively carried out on RFIC design technology for implementing the miniaturization, low power consumption, and high integration of devices while maintaining processing performance of a radio frequency (RF) signal.

In particular, there is an increasing demand for technology that integrates a plurality of transmission and reception paths within a limited chip area. To achieve this, it may be necessary to develop RFICs that maintain communication performance (e.g., an error vector magnitude (EVM)) despite minimizing a chip area by simplifying a circuit structure or removing unnecessary components.

### SUMMARY

One or more embodiments of the present disclosure provide a radio frequency integrated circuit, an operating method thereof, and an electronic device, which may maintain a communication performance while minimizing a chip area by using a shared capacitor.

In one or more embodiments, a radio frequency integrated circuit (RFIC) may include: a first radio frequency (RF) chain; and a second RF chain different from the first RF chain, wherein a target circuit in the first RF chain may be selectively connected to at least one shared capacitor in the second RF chain through a plurality of switch elements.

In one or more embodiments, there is provided an operating method of a radio frequency integrated circuit (RFIC) including a first radio frequency (RF) chain and a second RF chain. The operating method may include: receiving a capacitor sharing request from a target circuit of the first RF chain; determining a shared capacitance requested by the target circuit; generating a control signal to form at least one shared capacitor, based on the shared capacitance; and connecting the target circuit to the at least one shared capacitor, based on the control signal.

In one or more embodiments, an electronic device may include: at least one processor; a memory; and a wireless communication module including a radio frequency integrated circuit (RFIC), wherein the RFIC may include: a first radio frequency (RF) chain, including a target circuit; a second radio frequency (RF) chain, wherein the second RF chain may be different from the first RF chain; at least one shared capacitor included in the second RF chain, a plurality of switch elements configured to selectively connect the target circuit in the first RF chain to the at least one shared capacitor in the second RF chain; and a capacitance controller coupled to the plurality of switch elements, the capacitance controller configured to: receive a capacitor sharing request from the target circuit, determine a required shared capacitance based on the capacitor sharing request, generate a control signal to selectively connect the target circuit to the at least one shared capacitor based on the required shared capacitance, and transmit the control signal to the plurality of switch elements to configure an electrical connection between the target circuit and the at least one shared capacitor.

### BRIEF DESCRIPTION OF DRAWINGS

Embodiments will be more clearly understood from the following detailed description taken in conjunction with the accompanying drawings in which:

FIG. 1 is a block diagram of a wireless communication device according to one or more embodiments;

FIG. 2 is a block diagram of a radio frequency integrated circuit according to one or more embodiments;

FIG. 3 is a circuit diagram for describing an example of an operation of sharing a capacitor in a radio frequency integrated circuit according to one or more embodiments;

FIG. 4 is a diagram for describing another example of an operation of sharing a capacitor in a radio frequency integrated circuit according to one or more embodiments;

FIG. 5 is a diagram for describing an example of an operation of a radio frequency integrated circuit according to one or more embodiments;

FIG. 6 is a diagram for describing an operating method of a radio frequency integrated circuit, according to one or more embodiments;

FIG. 7 is a diagram for comparing performance of a radio frequency integrated circuit according to one or more embodiments with performance of a radio frequency integrated circuit according to a comparative example;

FIG. 8 is a block diagram of an electronic device according to one or more embodiments; and

FIG. 9 is a diagram illustrating examples of electronic devices to which one or more embodiments is applied.

### DETAILED DESCRIPTION

Hereinafter, embodiments will be described in detail with reference to the accompanying drawings. Embodiments are illustrated in the drawings and are described in the detailed description, but this does not limit various embodiments to a specific form. For example, it is obvious to those of ordinary skill in the art that embodiments may be variously modified.

Hereinafter, a wireless communication device 10 (or a radio frequency integrated circuit (RFIC) 110) according to one or more embodiments may operate in a time-division manner, alternating between a transmit mode and a receive mode based on a time division duplex (TDD) scheme. In the TDD scheme, the wireless communication device 10 may use the same frequency band for both transmission and reception, but the transmission and reception operations may be time-separated into distinct time slots.

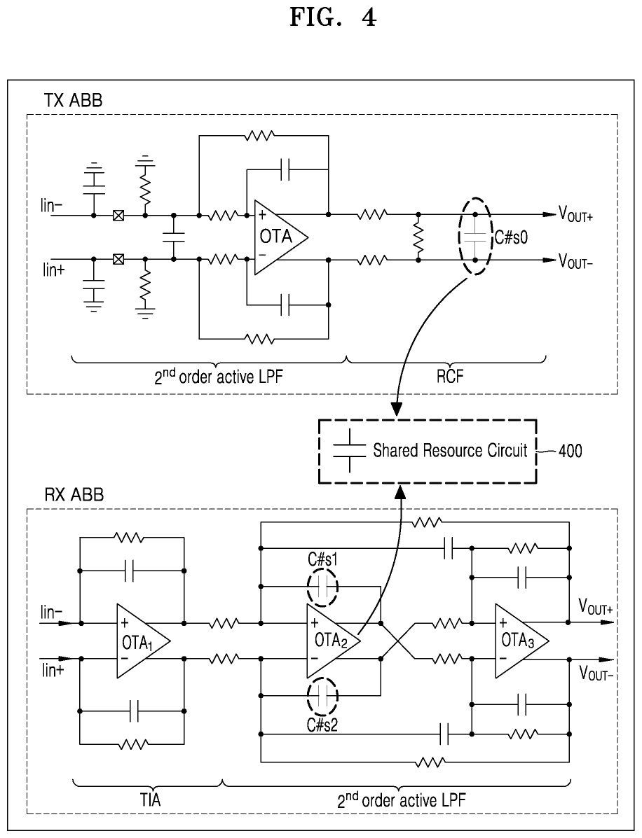

Hereinafter, a first radio frequency (RF) chain according to one or more embodiments may refer to an RF chain (i.e., an RF chain provided with a shared capacitor) that transmits a capacitor sharing request, and a second RF chain may refer to an RF chain that provides a shared capacitor. However, in a case which shares a shared capacitor included in a shared resource circuit (for example, 400 of FIG. 4), each of the first RF chain and the second RF chain may be an RF chain which transmits the capacitor sharing request.

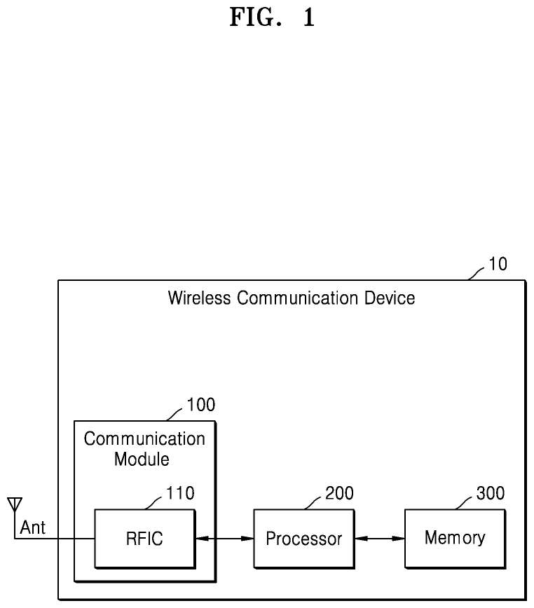

FIG. 1 is a block diagram of the wireless communication device 10 according to one or more embodiments.

Referring to FIG. 1, the wireless communication device 10 according to one or more embodiments may include a communication module 100, a processor 200, and a memory 300.

The wireless communication device 10 may be referred to as user equipment (UE), a mobile station (MS), a mobile terminal (MT), a user terminal, a subscribe station (SS), a wireless device, or a handheld device.

The wireless communication device 10 may support 4G communication (for example, long term evolution (LTE), LTE-advanced (LTE-A), 5G communication (for example, a new radio (NR), etc.) defined in 3rd generation partnership project (3GPP) standard.

For 4G communication and 5G communication, the wireless communication device 10 may support communication protocol based on code division multiple access (CDMA), communication protocol based on wideband CDMA (WCDMA), communication protocol based on time division multiple access (TDMA), communication protocol based on frequency division multiple access (FDMA), communication protocol based on orthogonal frequency division multiplexing (OFDM), communication protocol based on cyclic prefix (CP)-OFDM, communication protocol based on discrete Fourier transform-spread-OFDM (DFT-s-OFDM), communication protocol based on non-orthogonal multiple access (NOMA) and generalized frequency division multiplexing (GFDM).

The wireless communication device 10 may include a wireless communication module (for example, a cellular communication module, a short-distance wireless communication module, or a global navigation satellite system (GNSS) communication module) or a wired communication module (for example, a local area network (LAN) communication module or a low power communication module). The wireless communication device 10 may communicate with an external electronic device through a first network (for example, a short-distance communication network such as Bluetooth, WiFi direct, or infrared data association (IrDA)) or a second network (for example, a long-distance communication network such as a cellular network, Internet, or a computer network (for example, LAN or wide area network (WAN)). Several kinds of communication modules may be implemented with one element (for example, a single chip) or a plurality of elements (for example, a plurality of chips).

The communication module 100 may be electrically connected to a plurality of antennas Ant and may support the establishment of a communication channel with an external device and communication performance based on an established communication channel. In other words, the communication module 100 may transmit or receive radio frequency (RF) signals through the plurality of antennas Ant to communicate with an external device.

The communication module 100 may receive data signals (for example, a data symbol) from the processor 200. The communication module 100 may encode, multiplex, and/or analog-convert received data signals. The communication module 100 may frequency-up-convert intermediate-frequency or baseband signals output from the processor 200 to transmit as RF signals to an external device through the plurality of antennas Ant. For example, the communication module 100 may communicate with an external device, based on a TDD scheme.

The communication module 100 may down-convert RF signals received from an external electronic device to generate intermediate-frequency or baseband signals. The communication module 100 may filter, decode, and/or digitize (for example, sample) the baseband signals to convert into a data signal (hereinafter referred to as a digital reception signal). The communication module 100 may include the radio frequency integrated circuit (RFIC) 110.

The RFIC 110 may be connected to the antenna Ant and may receive a signal from an external device or may transmit a signal to the external device through a wireless communication network. The RFIC 110 according to one or more embodiments may be configured for use in a first network (for example, a short-distance communication network such as Bluetooth, WiFi direct, or infrared data association (IrDA)). However, the disclosure is not limited thereto, and according to embodiments, the RFIC 110 may be applied to a second network, such as, a long-distance communication network including a cellular network, Internet, or a computer network (for example, LAN or WAN).

The RFIC 110 may be a semiconductor chip in which various circuit elements for processing a high frequency signal are integrated. The RFIC 110 may include a transmit path (Tx path) and a receive path (Rx path), and a corresponding RF chain may be provided for each path.

Each of a plurality of RF chains may include a plurality of functional circuits. An RF chain of the transmit path may include a digital-to-analog converter (DAC) configured to convert a digital signal into an analog signal, a mixer (Mixer) configured to up-convert a frequency of a converted signal, a transmission analog baseband circuit (TX ABB) configured to adjust a frequency component of a signal, and a power amplifier (PA) configured to amplify a transmission signal with a high output to transmit an amplified transmission signal through an antenna. An RF chain of the receive path may include a low noise amplifier (LNA) configured to amplify a high frequency signal received through an antenna with low noise, a mixer configured to down-convert a high frequency signal into a low frequency signal, a reception analog baseband circuit (RX ABB) configured to filter and amplify a reception signal, and an analog-to-digital converter (ADC) configured to convert an amplified reception signal into a digital signal.

Recently, there has been an increasing demand for technology that integrates a plurality of transmit paths within a limited chip area. Particularly, it may be required to develop RFICs that maintain, or minimize degradation of, a communication performance despite minimizing a chip area.

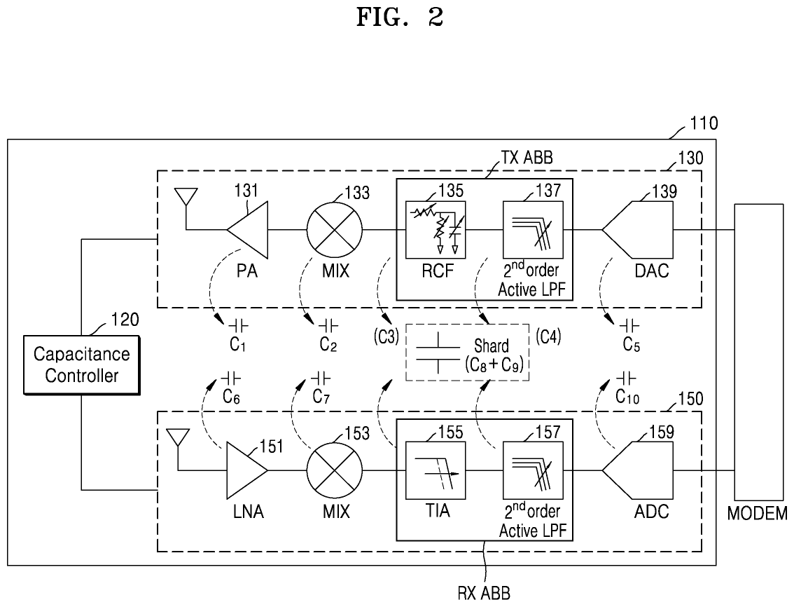

Accordingly, in the RFIC 110 according to one or more embodiments, a capacitor may be shared between circuits included in the RFIC 110, and thus, a total chip area may be reduced, and the manufacturing cost may decrease. Hereinafter, a capacitor shared between circuits may be referred to as a shared capacitor. This will be described below in detail with reference to FIGS. 2 to 7.

An RFIC according to one or more embodiments may include a first RF chain and a second RF chain which differs from the first RF chain, and a target circuit included in the first RF chain may be selectively connected to at least one shared capacitor included in the second RF chain or in a shared resource circuit (e.g., a shared resource circuit 400 in FIG. 4) by using a plurality of switch elements.

A capacitance controller (120 of FIG. 2) included in the RFIC 110 according to one or more embodiments may determine a shared capacitance requested by a target circuit, may generate a control signal to form at least one shared capacitor, based on the shared capacitance, and may transmit the control signal to a plurality of switch elements to connect the target circuit to the at least one shared capacitor. The target circuit may generate a capacitor sharing request when that target circuit requires an effective capacitance exceeding or differing from its locally available capacitance. The capacitor sharing request may be triggered, for example, by a mode change (Tx/Rx switching in a TDD scheme), a bandwidth or frequency reconfiguration, or a power-saving operation in which on-chip capacitors of inactive RF chains are reused. In this case, the capacitance controller (120 of FIG. 2) may select a capacitor, having a capacitance which is greater than or equal to the shared capacitance, from among a plurality of capacitors (included in the second RF chain or the shared resource circuit) to form at least one shared capacitor, or may selectively combine the plurality of capacitors (included in the second RF chain or the shared resource circuit) to form at least one shared capacitor having a capacitance which is greater than or equal to the shared capacitance. Each requesting target circuit may be coupled to the capacitance controller 120 through a set of electrical interconnections, such as analog signal lines or dedicated control wires. The capacitor sharing request may include information indicating a requesting RF chain (e.g., a transmission RF chain 130 or a reception RF chain 150), a target functional circuit, and a required capacitance value or capacitance range. The capacitor sharing request may be generated by local control logic within the functional circuit or by higher-level RF chain control logic associated with modem or baseband scheduling.

The capacitance controller 120 may be implemented as a centralized control block on the RFIC, including digital logic (e.g., registers, decoders, and combinational logic) and, in some embodiments, analog circuitry. The capacitance controller 120 may maintain configuration information regarding available capacitors distributed across functional circuits in different RF chains and their availability based on the TDD timing and operating mode. Upon receiving a capacitor sharing request, the capacitance controller 120 may determine whether one or more capacitors in another RF chain are available (i.e., not active during the same time resource). The capacitance controller 120 may then calculate a shared capacitance by selecting and combining one or more available capacitors. To physically realize the sharing, the capacitance controller 120 may generate control signals that drive a plurality of switch elements (e.g., MOS switches or transmission gates). These switch elements may selectively connect or disconnect the selected capacitors to the requesting functional circuit while isolating them from their original circuit, thereby forming a reconfigurable capacitance network. Through this mechanism, the capacitance controller 120 may dynamically reallocate capacitors across RF chains while maintaining signal isolation and avoiding interference between concurrently operating circuits.

The first RF chain and the second RF chain according to one or more embodiments may be RF chains which independently operate without sharing the same time resource, based on a TDD scheme.

The processor 200 may be an internal operation processing unit and may include a central processing unit (CPU) 111, a graphics processing unit (GPU) 112, and a neural processing unit (NPU) 113, and the processor 200 may execute one or more instructions (software). The processor 200 may be implemented with a logic block formed through a logic synthesis, a software block executed by the processor 200, or a combination thereof. The processor 200 may include a set of a plurality of instructions, which may be stored in the memory 300 and accessible and executable by the processor 200.

The processor 200 may execute one or more instructions to control another element (for example, a hardware or software element) included in the wireless communication device 10, and moreover, may perform various data processing or operations in the wireless communication device 10. For example, the processor 200 may load an instruction or data, received from another element, as at least a portion of data processing or operation into a volatile memory, may process an instruction or data stored in the volatile memory, and may store result data in a non-volatile memory. As another example, the processor 200 may include a main processor (for example, a CPU or an application processor) and an auxiliary processor (for example, a GPU, an image signal processor, a sensor hub processor, or a communication processor) capable of being executed independently of the main processor or together. The auxiliary processor may use power which is lower than the main processor, or may be set to be specific to a designated function. The auxiliary processor may be implemented separately from the main processor or a portion thereof.

The memory 300 may store one or more instructions. Also, the memory 300 may store various pieces of data used by at least one element (for example, the processor 200) of the communication module 100. The data may include one or more instructions (software) and input data or output data corresponding to an instruction relevant thereto. The memory 300 may include a volatile memory or a non-volatile memory. A program may be stored as software in the memory 300, and for example, may include an operating system (OS), middleware, or an application.

FIG. 2 is a block diagram of an RFIC according to one or more embodiments.

In FIG. 2, the wireless communication device 10 according to one or more embodiments may time-divisionally operate in a transmit mode and a receive mode, based on a TDD scheme.

Referring to FIG. 2, the RFIC 110 may include a plurality of RF chains and a capacitance controller 120, in order to process a high frequency signal. In this case, the RFIC 110 may include a transmission RF chain 130 corresponding to a transmit path and a reception RF chain 150 corresponding to a receive path. The transmission RF chain 130 and the reception RF chain 150 may be electrically connected to a modem. Each of the plurality of RF chains may include a plurality of functional circuits.

The transmission RF chain 130 may include a digital-to-analog converter (DAC) 139 configured to convert a digital signal received from the modem into an analog signal, transmission analog baseband circuits (TX ABB) configured to adjust frequency components of the analog signal, a mixer (Mixer) 133 configured to frequency-up-convert the adjusted analog signal, and a power amplifier (PA) 131 configured to amplify the up-converted signal analog to a high output level for transmission through an antenna. The transmission analog baseband circuits (TX ABB) may include a resistor-capacitor filter (RCF) 135 and a second-order active low pass filter (LPF) 137.

The reception RF chain 150 may include a low noise amplifier (LNA) 151 which amplifies a high frequency signal received through an antenna with low noise, a mixer 153 which down-converts a high frequency signal into a low frequency signal, reception analog baseband circuits (RX ABB) which filter and amplify a reception signal, and an analog-to-digital converter (ADC) 159 which converts an amplified reception signal into a digital signal. In this case, the reception analog baseband circuits (RX ABB) may include a transimpedance amplifier (TIA) 155 and a second-order active LPF 157.

Functional circuits included in the transmission RF chain 130 and the reception RF chain 150 described above may each include at least one capacitor, in order to support a bandwidth for processing a wireless signal. For example, the power amplifier PA 131 may include a capacitor C1, the mixer 133 may include a capacitor C2, the RCF 135 may include a capacitor C3, the second-order active LPF 137 may include a capacitor C4, and the DAC 139 may include a capacitor C5. For example, the LNA 151 may include a capacitor C6, the mixer 153 may include a capacitor C7, the second-order active LPF 157 may include a capacitor C8 and a capacitor C9, and the ADC 159 may include a capacitor C10. For convenience of description, a capacitor included in each of the functional circuits may be implemented as one capacitor (for example, C1 or C2), but is not limited thereto and may represent a combination of a plurality of capacitors included in each functional circuit.

A bandwidth of a functional circuit for processing a wireless signal may be determined by a multiplication of a resistance value and a capacitance (R×C). In a method of decreasing a chip area of the RFIC 110, a configuration which increases a resistance value and decreases a capacitance may be considered, but in this case, noise caused by a resistor may increase, causing a degradation in performance of the RFIC 110.

In the RFIC 110 according to one or more embodiments, a capacitor may be shared between different RF chains (i.e., functional circuits included in an RF chain) by using the capacitance controller 120, based on a TDD scheme. The functional circuits included in the transmission RF chain and the reception RF chain may transmit a capacitor sharing request to the capacitance controller 120. Hereinafter, an RF chain (i.e., an RF chain provided with a shared capacitor) which has transmitted the capacitor sharing request may be referred to as a first RF chain, and an RF chain providing the shared capacitor may be referred to as a second RF chain. Here, the second RF chain may be different from the first RF chain, and based on a TDD scheme, the second RF chain may operate independently of the first RF chain by using a time resource which differs from a time resource used by the first RF chain. Herein, a structure may be adopted where the first RF chain and the second RF chain time-divisionally operate in the transmit mode and the receive mode, based on a TDD scheme. That is, the first and second RF chains may not share the same time resource and may independently operate in each mode. For example, when the first RF chain is a transmission RF chain, the second RF chain may be a reception RF chain, and when the first RF chain is a reception RF chain, the second RF chain may be a transmission RF chain.

Also, in one or more embodiments, the first RF chain and the second RF chain may not be used as a digital pre-distribution (DPD) path therebetween. Here, the DPD path may denote a feedback path which collects a signal (i.e., a transmission signal) output from the transmission RF chain to correct distortion of the signal (for example, nonlinear distortion). A DPD circuit may learn a distortion characteristic of the transmit path, based on the transmission signal collected through the DPD path, and thus, may set a correction coefficient which is to be applied to the transmission signal. The DPD path may be implemented with a separate RF chain, or may be implemented with a conventional reception RF chain.

According to one or more embodiments, at least some of a plurality of reception RF chains may be used as a DPD path of the transmission RF chain. For example, when a transmission RF chain and a reception RF chain corresponding to the same wireless path form a pair of RF chains, the reception RF chain may operate as a DPD path of the transmission RF chain of the same pair. For example, a transmission RF chain corresponding to a WL0 path may be a WL0 transmission RF chain, and a reception RF chain may be a WL0 reception RF chain. In this case, while the WL0 transmission RF chain is operating in the transmit mode, the WL0 reception RF chain (included in the same pair as the WL0 transmission RF chain) may be used as a DPD path of the WL0 transmission RF chain, and thus, a separate RF chain for the DPD path may not be needed.

Each of the first RF chain and the second RF chain according to one or more embodiments may independently operate in the transmit mode and the receive mode, and the first RF chain and the second RF chain may not be used as a DPD path therebetween. In other words, in an entire operate mode including a normal operate mode (for example, transmit/receive mode) and a DPD mode, the first RF chain and the second RF chain may not share the same time resource and may independently operate by using different time resources in a state where an isolation characteristic of a signal is guaranteed. For example, when the first RF chain is the transmission RF chain corresponding to the WL0 path, namely, when the first RF chain is the WL0 transmission RF chain, the second RF chain may be a reception RF chain which is not used as a DPD path of the first RF chain, namely, may be a WL1 reception RF chain corresponding to a WL1 path. In this case, the first RF chain (the WL0 transmission RF chain) and the second RF chain (the WL1 reception RF chain) may independently operate by using different time resources in the transmit mode and the receive mode, based on a TDD scheme. Also, the first RF chain (the WL0 transmission RF chain) and the second RF chain (the WL1 reception RF chain) may respectively correspond to different wireless paths (for example, WL0 and WL1), and thus, may independently operate by using different time resources in the DPD mode (i.e., the second RF chain (the WL1 reception RF chain) may not operate as a DPD path of the first RF chain (the WL0 transmission RF chain). Therefore, the first RF chain (the WL0 transmission RF chain) and the second RF chain (the WL1 reception RF chain) according to one or more embodiments may independently operate by using different time resources in an entire operate mode, and thus, the first RF chain (the WL0 transmission RF chain) and the second RF chain (the WL1 reception RF chain) may share at least one capacitor.

The capacitance controller 120 may receive a capacitor sharing request from at least one functional circuit of the first RF chain and may control sharing of at least one capacitor of the second RF chain, in response to the capacitor sharing request. For example, when the first RF chain is a transmission RF chain, in response to receiving a capacitor sharing request from at least one functional circuit (hereinafter referred to as a first target circuit) among the PA 131, the mixer 133, the RCF 135, the second-order active LPF 137, and the DAC 139, the capacitance controller 120 may perform control so that an internal capacitor of at least one of the LNA 151, the mixer 153, the TIA 155, the second-order active LPF 157, and the ADC 159 of the second RF chain is shared by (connected to) the first target circuit. For example, when the first RF chain is a reception RF chain, in response to receiving the capacitor sharing request from at least one functional circuit (hereinafter referred to as a second target circuit) among the LNA 151, the mixer 153, the TIA 155, the second-order active LPF 157, and the ADC 159, the capacitance controller 120 may perform control so that an internal capacitor of at least one of the PA 131, the mixer 133, the RCF 135, the second-order active LPF 137, and the DAC 139 of the first RF chain is shared by the second target circuit.

For example, in response to receiving the capacitor sharing request from the RCF 135 and the second-order active LPF 137 (a target circuit) of the transmission RF chain 130 (the first RF chain), the capacitance controller 120 may perform control to connect the RCF 135 and the second-order active LPF 137 (the target circuit) to a shared capacitor included in the reception RF chain 150 (the second RF chain). Here, a target circuit may denote a functional circuit which includes a shared capacitor. The capacitance controller 120 may determine/calculate a shared capacitance (for example, a total sum of the capacitor C3 and the capacitor C4) requested by the RCF 135 and the second-order active LPF 137 (a target circuit) of the transmission RF chain 130 (the first RF chain). The capacitance controller 120 may selectively combine at least one shared capacitors to generate a control signal for forming a shared capacitance. The capacitance controller 120 may apply the generated control signal to a plurality of switch elements to connect the RCF 135 and the second-order active LPF 137 (the target circuit) to at least one shared capacitors. Here, the at least one shared capacitors may include a capacitor C8 included in the TIA 155 and a capacitor C9 included in the second-order active LPF 157. Also, the plurality of switches may operate as a path for selectively configuring an electrical connection between the at least one shared capacitor and the target circuit (for example, the RCF 135 and the second-order active LPF 137). The control signal generated by the capacitance controller 120 may be applied to each of the plurality of switch elements. Based on the control signal, the plurality of switch elements may be selectively changed to an on/off state, and thus, the shared capacitor may be connected to or isolated from the target circuit (for example, the RCF 135 and the second-order active LPF 137). Accordingly, the capacitance controller 120 may perform control to selectively combine at least one shared capacitors to form a shared capacitance.

In the RFIC 110 according to one or more embodiments, a dedicated capacitor individually disposed in each of a plurality of functional circuits may be replaced with a shared capacitor, and thus, a dedicated capacitor included in each circuit may be removed.

As described above, the capacitance controller 120 may be configured so that a shared capacitor is selectively connected to a target circuit depending on the case, and thus, the placement of an overlapping capacitor (for example, a dedicated capacitor) in a circuit may be omitted while maintaining the same performance. As a result, an area, occupied by the dedicated capacitor, of the RFIC 110 may be reduced, thereby contributing to the efficient use of a chip area and a reduction in the manufacturing cost. For example, in the RFIC 110 according to one or more embodiments, a capacitor may be shared between the transmission RF chain 130 (the first RF chain) and the reception RF chain 150 (the second RF chain) in FIG. 2, and thus, all (maximum) of an area corresponding to the capacitor C1 to the capacitor C5 or at least a portion of the area corresponding to the capacitor C1 to the capacitor C5 may be reduced.

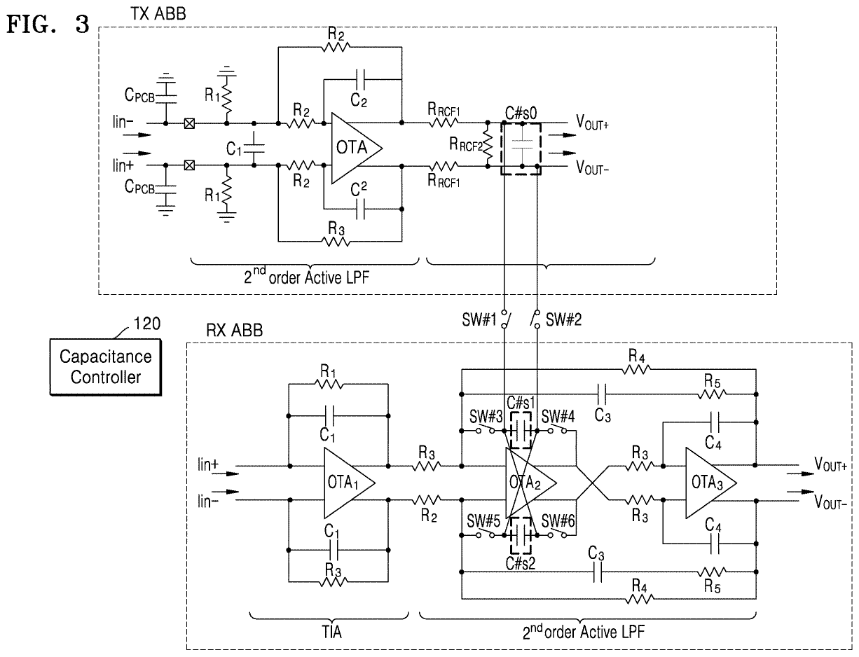

FIG. 3 is a circuit diagram for describing an example of an operation of sharing a capacitor in an RFIC according to one or more embodiments.

In FIG. 3, a transmission RF chain may be a first RF chain, a reception RF chain may be a second RF chain, and an RCF 135 included in TX ABB may be a target circuit. Accordingly, a transmission RF chain (a first RF chain) and a reception RF chain (a second RF chain) may not share the same time resource, based on a TDD scheme. That is, in an entire operate mode including an operation of a normal operate mode (for example, an operation of a transmit mode and an operation of a receive mode) and an operation of a DPD mode, the transmission RF chain and the reception RF chain may independently operate in a state where an isolation characteristic of a signal is guaranteed. For example, in the RFIC 110 operating based on a TDD scheme, TX ABB of the transmission RF chain (the first RF chain) may be included in ‘WL0 TX ABB’, and RX ABB of the reception RF chain (the second RF chain) may be included in ‘WL1 RX ABB’ (where WL may denote WLAN). Description overlapping the above description is omitted.

Referring to FIG. 3, based on a capacitance controller 120, an RCF 135 (a target circuit) included in the TX ABB and a second-order active LPF 157 included in the RX ABB may share a capacitor therebetween.

The capacitance controller 120 may receive a capacitor sharing request from the RCF 135 (the target circuit) included in the TX ABB of the transmission RF chain. The RCF 135 may transmit the capacitor sharing request to the capacitance controller 120 in an operate mode of the transmission RF chain.

The capacitance controller 120 may perform control to connect the RCF 135 (the target circuit) to at least one shared capacitor, in response to receiving the capacitor sharing request from the RCF 135 (the target circuit).

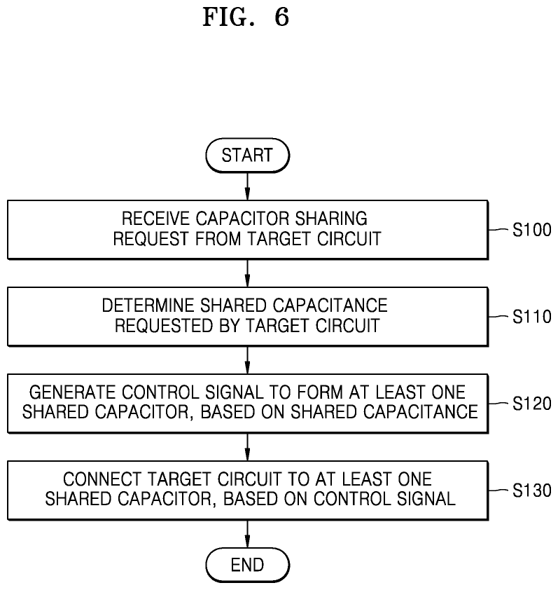

In one or more embodiments, the capacitance controller 120 may determine/calculate a shared capacitance (for example, a capacitance of C #s0 of FIG. 6) requested by the RCF 135 (the target circuit). Here, the shared capacitance may denote a certain capacitance value desired by the target circuit. The capacitance controller 120 may determine a shared capacitance included in the received capacitor sharing request, or may calculate the shared capacitance, based on pre-stored information (for example, capacitance information desired by each of functional circuits).

In one or more embodiments, the capacitance controller 120 may generate a control signal to form at least one shared capacitor, based on the shared capacitance. The capacitance controller 120 may select a capacitor, having a capacitance which is greater than or equal to the shared capacitance, as at least one shared capacitor from among a plurality of capacitors included in the reception RF chain (the second RF chain), or may selectively combine the plurality of capacitors included in the reception RF chain (the second RF chain) to form at least one shared capacitor. In this case, the formed at least one shared capacitor may have a capacitance which is greater than or equal to the shared capacitance. For example, the capacitance controller 120 may generate a control signal for first to sixth switch elements SW #1 to SW #6, so as to selectively combine capacitors (for example, C #s1 and C #s2) included in the second-order active LPF 157 to form at least one shared capacitor having a capacitance which is greater than or equal to the shared capacitance.

In one or more embodiments, the capacitance controller 120 may transmit the control signal to a plurality of switch elements (for example, the first to sixth switch elements SW #1 to SW #6) to connect the RCF 135 (the target circuit) to at least one shared capacitors (for example, C #s1 and C #s2). Here, the plurality of switch elements (for example, the first to sixth switch elements SW #1 to SW #6) may each operate as a path for selectively configuring an electrical connection between the at least one shared capacitors (for example, C #s1 and C #s2) and a target circuit (for example, the RCF 135). The control signal generated by the capacitance controller 120 may be applied to each of the plurality of switch elements (for example, the first to sixth switch elements SW #1 to SW #6). Based on the control signal, the plurality of switch elements (for example, the first to sixth switch elements SW #1 to SW #6) may be selectively changed to an on/off state, and thus, may connect or isolate the target circuit (for example, the RCF 135) to or from the shared capacitors (for example, C #s1 and C #s2). Also, based on the plurality of switch elements (for example, the first to sixth switch elements SW #1 to SW #6), the capacitance controller 120 may selectively combine a plurality of capacitors included in the second RF chain to form at least one shared capacitor having a capacitance which is greater than or equal to a shared capacitance.

For example, when the RFIC 110 is in the transmit mode, based on the control signal of the capacitance controller 120, the first switch element SW #1 and the second switch element SW #2 may be turned on, and the third to sixth switch elements SW #3 to SW #6 may be turned off. Based on an operation of a switch element described above, the RCF 135 (the target circuit) may be connected to the shared capacitors (for example, C #s1 and C #s2), and the second-order active LPF 157 may be isolated from the shared capacitors (for example, C #s1 and C #s2). The RCF 135 (the target circuit) may be connected to the shared capacitors (for example, C #s1 and C #s2), and thus, may use a shared capacitance. That is, the RCF 135 (the target circuit) may use the shared capacitors (for example, C #s1 and C #s2) so as to process a transmission signal during the transmit mode, and thus, the placement of the dedicated capacitor (for example, C #s0) may be omitted.

For example, when the RFIC 110 is in the receive mode, based on the control signal of the capacitance controller 120, the first switch element SW #1 and the second switch element SW #2 may be turned off, and the third to sixth switch elements SW #3 to SW #6 may be turned on. Based on an operation of a switch element described above, the RCF 135 (the target circuit) may be isolated from the shared capacitors (for example, C #s1 and C #s2), and the second-order active LPF 157 may be connected to the shared capacitors (for example, C #s1 and C #s2). The second-order active LPF 157-included in the RX ABB may use the shared capacitors (for example, C #s1 and C #s2) so as to process a reception signal during the receive mode.

In the RFIC 110 according to one or more embodiments, a dedicated capacitor individually disposed in each of a plurality of functional circuits may be replaced with the shared capacitors (for example, C #s1 and C #s2), and thus, a dedicated capacitor included in each circuit may be removed.

As described above, the RFIC 110 according to one or more embodiments may be configured so that a target circuit is selectively connected to the shared capacitors (for example, C #s1 and C #s2), based on an operate mode, and thus, the placement of an overlapping capacitor (i.e., the dedicated capacitor (for example, C #s0)) in each circuit may be omitted while maintaining the same performance. As a result, an area, occupied by the dedicated capacitor (for example, C #s0), of the RFIC 110 may be reduced, thereby contributing to the efficient use of a chip area and a reduction in the manufacturing cost.

In FIG. 3, for convenience of description, it is illustrated that a capacitor is shared between the TX ABB and the RX ABB, but the disclosure is not limited thereto. In the RFIC 110 according to one or more embodiments, a capacitor may be shared between at least one functional circuits included in the transmission RF chain (for example, the first RF chain) and at least one functional circuits included in the reception RF chain (for example, the second RF chain), based on various combinations.

FIG. 4 is a diagram for describing another example of an operation of sharing a capacitor in an RFIC according to one or more embodiments.

Referring to FIG. 4, a shared capacitor according to one or more embodiments may be included in a shared resource circuit 400 formed in a region separated from a first RF chain and a second RF chain, in the RFIC. For example, the shared capacitor of FIG. 3 may be included in the second RF chain (or at least one functional circuit of the second RF chain) which differs from the first RF chain, but the shared capacitor of FIG. 4 may be included in the shared resource circuit 400 formed in an external region outside the first RF chain and the second RF chain, in the RFIC.

In the RFIC 110 according to one or more embodiments, a dedicated capacitor (for example, C #s0, C #s1, and C #s2) individually disposed in each of a plurality of functional circuits may be replaced with a shared capacitor included in the shared resource circuit 400, and thus, the dedicated capacitor (for example, C #s0, C #s1, and C #s2) included in each circuit may be removed.

As described above, the RFIC 110 according to one or more embodiments may be configured so that a target circuit is selectively connected to a shared capacitor included in the shared resource circuit 400, based on an operate mode, and thus, the placement of an overlapping capacitor (i.e., the dedicated capacitor (for example, C #s0, C #s1, and C #s2)) in each circuit may be omitted while maintaining the same performance. As a result, an area, occupied by the dedicated capacitor (for example, C #s0, C #s1, and C #s2), of the RFIC 110 may be reduced, thereby contributing to the minimization of a chip area and a reduction in the manufacturing cost.

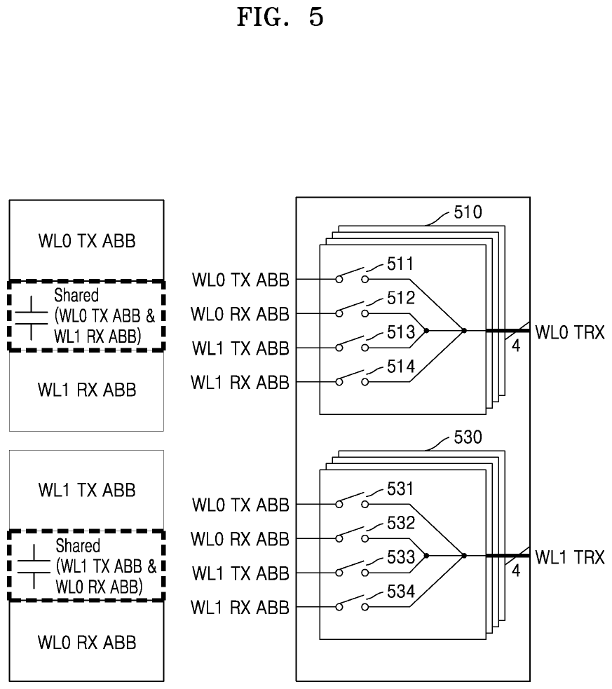

FIG. 5 is a diagram for describing an example of an operation of an RFIC according to one or more embodiments.

Referring to FIG. 5, the RFIC 110 may operate based on a TDD scheme, and a first RF chain and a second RF chain may not share the same time resource and may independently operate. Description overlapping the above description is omitted.

In FIG. 5, it may be assumed that TX ABB of WL0 and RX ABB of WL1 share at least one first shared capacitor included in the RX ABB of the WL1, and TX ABB of the WL1 and RX ABB of the WL0 share at least one second shared capacitor included in the RX ABB of the WL0.

Referring to FIG. 5, in the RFIC 110, a first connection circuit 510 and a second connection circuit 530 may selectively connect or isolate a plurality of TX ABBs and RX ABBs with or from each other by using a plurality of switch elements, based on an operate mode (for example, the transmit mode or the receive mode). For example, in the transmit mode of the WL0, a switch element 511 connected to TX ABB of WL0 in the first connection circuit 510 may be turned on, and the other switch elements 512 to 514 may be turned off. A switch element 532 connected to RX ABB of WL0 in the second connection circuit 530 may be turned on (a DPD mode), and the other switch elements 531, 533, and 534 may be turned off. For example, in the receive mode of the WL0, the switch element 512 connected to the RX ABB of the WL0 in the first connection circuit 510 may be turned on, and the other switch elements 511, 513 to 514, and 531 to 534 may be turned off.

When the RFIC 110 operates in the transmit mode of the WL0, the capacitance controller 120 may generate a control signal for connecting the TX ABB of the WL0 to a first shared capacitor to control a plurality of switch elements, in response to receiving a capacitor sharing request from the TX ABB (a target circuit) of the WL0.

The capacitance controller 120 may selectively combine a plurality of capacitors included in the RX ABB of the WL1 to form the first shared capacitor, based on a shared capacitance requested by the TX ABB (the target circuit) of the WL0, and may perform control so that the TX ABB (the target circuit) of the WL0 is connected to the first shared capacitor included in the RX ABB of the WL1.

The TX ABB (a first RF chain) of the WL0 and the RX ABB (a second RF chain) of the WL1 may not share the same time resource, based on a TDD scheme. That is, in an entire operation including an operation of the normal operate mode (for example, an operation of the transmit mode and an operation of the receive mode) and an operation of the DPD mode, elements may independently operate in a state where an isolation characteristic of a signal is guaranteed. The TX ABB (the first RF chain) of the WL0 and the RX ABB (the second RF chain) of the WL1 may independently operate in different time resources, and thus, may share the first shared capacitor.

In the RFIC 110, a first connection circuit 510 and a second connection circuit 530 may selectively connect or isolate a plurality of TX ABBs and RX ABBs with or from each other by using a plurality of switch elements, based on an operate mode (for example, the transmit mode or the receive mode). For example, in the transmit mode of the WL0, a switch element 511 connected to TX ABB of WL0 in the first connection circuit 510 may be turned on, and the other switch elements 512 to 514 and 531 to 534 may be turned off. In the transmit mode of the WL1, the switch element 533 connected to the TX ABB of the WL1 in the second connection circuit 530 may be turned on, and the other switch elements 511 to 514, 531, 532, and 534 may be turned off. For example, in the DPD mode of the WL0, the switch element 511 connected to the TX ABB of the WL0 in the first connection circuit 510 may be turned on, the switch element 532 connected to the RX ABB of the WL0 in the second connection circuit 530 may be turned on, and the other switch elements 512 to 514, 531, 533, and 534 may be turned off. In the DPD mode of the WL1, the switch element 514 connected to the RX ABB of the WL1 in the first connection circuit 510 may be turned on, the switch element 533 connected to the TX ABB of the WL1 in the second connection circuit 530 may be turned on, and the other switch elements 511 to 513, 531, 532, and 534 may be turned off. For example, in the receive mode of the WL1, the switch element 511 connected to the RX ABB of the WL0 in the first connection circuit 510 may be turned on, and the other switch elements 511, 513, 514, and 531 to 534 may be turned off. In the receive mode of the WL1, the switch element 534 connected to the RX ABB of the WL1 in the second connection circuit 530 may be turned on, and the other switch elements 511 to 514 and 531 to 533 may be turned off.

When the RFIC 110 operates in the transmit mode of the WL1, the capacitance controller 120 may generate a control signal for connecting the TX ABB of the WL1 to a second shared capacitor to control a plurality of switch elements, in response to receiving the capacitor sharing request from the TX ABB (a target circuit) of the WL1.

The capacitance controller 120 may selectively combine a plurality of capacitors included in the RX ABB of the WL0 to form the second shared capacitor, based on a shared capacitance requested by the TX ABB (the target circuit) of the WL1, and may perform control so that the TX ABB (the target circuit) of the WL1 is connected to the second shared capacitor included in the RX ABB of the WL0.

The TX ABB (a first RF chain) of the WL1 and the RX ABB (a second RF chain) of the WL0 may not share the same time resource, based on a TDD scheme. That is, in an entire operation including an operation of the normal operate mode (for example, an operation of the transmit mode and an operation of the receive mode) and an operation of the DPD mode, elements may independently operate in a state where an isolation characteristic of a signal is guaranteed. The TX ABB (the first RF chain) of the WL1 and the RX ABB (the second RF chain) of the WL0 may independently operate in different time resources, and thus, may share the second shared capacitor. Accordingly, in the RFIC 110, an operating method thereof, and an electronic device according to various embodiments, a capacitor may be shared between the elements of the RFIC 110 to decrease a circuit design area, based on a TDD scheme, and thus, a total chip area may be reduced while maintaining a high frequency characteristic and signal quality, and the manufacturing cost may decrease.

In FIG. 5, for convenience of description, it is illustrated that TX ABB and RX ABB corresponding to WL0 and WL1 are simplified, but the disclosure is not limited thereto. The RFIC 110 according to one or more embodiments may be applied to a device including a Tx RF chain and an Rx RF chain corresponding to a various number of WLs.

FIG. 6 is a diagram for describing an operating method of an RFIC, according to one or more embodiments.

Referring to FIG. 6, a method of sharing a capacitor between a first RF chain and a second RF chain by using the capacitance controller 120 of the RFIC 110 may include operations S100 to S130. Description overlapping the above description is omitted.

In FIG. 6, the RFIC 110 may time-divisionally operate in the transmit mode and the receive mode, based on a TDD scheme. The first RF chain and the second RF chain may independently operate without sharing the same time resource, based on a TDD scheme.

In operation S100, the capacitance controller 120 of the RFIC 110 may receive a capacitor sharing request from a target circuit of the first RF chain. For example, when the first RF chain is a transmission RF chain, and the second RF chain is a reception

RF chain, the target circuit may be at least one of a DAC, a transmit analog baseband (TX ABB), a mixer, a PA, and a combination thereof. As another example, when the first RF chain is the reception RF chain, and the second RF chain is the transmission RF chain, the target circuit may be at least one of an ADC, a receive analog baseband (RX ABB), a mixer, an LNA, and a combination thereof.

In operation S110, the capacitance controller 120 of the RFIC 110 may determine a shared capacitance requested by the target circuit.

In operation S120, the capacitance controller 120 of the RFIC 110 may generate a control signal to form at least one shared capacitor, based on the shared capacitance. For example, the capacitance controller 120 may select a capacitor, having a capacitance which is greater than or equal to the shared capacitance, from among a plurality of capacitors included in the second RF chain to form at least one capacitor, based on the control signal. For example, the capacitance controller 120 may selectively combine the plurality of capacitors included in the second RF chain to form at least one shared capacitor having a capacitance which is greater than or equal to the shared capacitance, based on the control signal.

In operation S130, the capacitance controller 120 of the RFIC 110 may connect the target circuit to the at least one shared capacitor, based on the control signal.

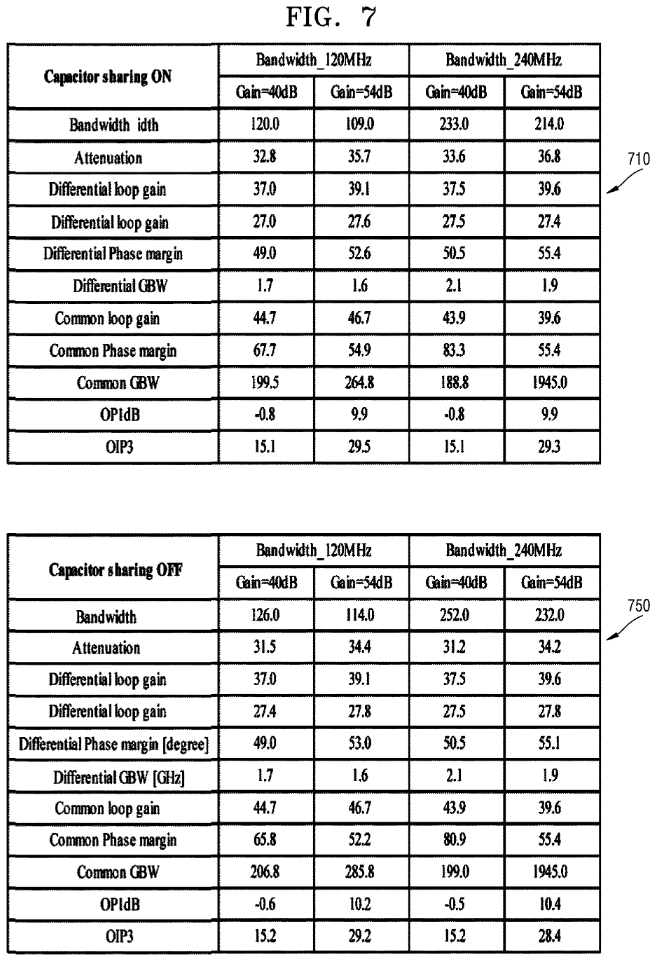

FIG. 7 is a diagram for comparing performance of an RFIC according to one or more embodiments with performance of an RFIC according to a comparative example.

In FIG. 7, a first table 710 shows a performance indicator of the RFIC 110 including a shared capacitor according to one or more embodiments and a second table 750 shows a performance indicator of an RFIC without a shared capacitor according to one or more embodiments.

In detail, the first table 710 and the second table 750 may include performance indicators of a bandwidth representing a frequency range enabling signal transfer, attenuation representing a degree of signal attenuation, a differential loop gain, a differential phase margin, a differential gain bandwidth product (GBW), a common loop gain, a common GBW, an output power at 1 dB compression point (OP1), and an output third-order intercept point (OIP3) with respect to variations of a bandwidth and a gain.

Referring to the first table 710 and the second table 750 of FIG. 7, it may be confirmed that the RFIC 110 according to one or more embodiments and an RFIC according to the comparative example have similar results. Particularly, in the OIP3 under a condition where a bandwidth is about 120 MHz and a gain is about 40 dB, it may be confirmed that a value of the RFIC 110 according to one or more embodiments and a value of the RFIC according to the comparative example are about 15.1 and about 15.2, respectively, and are at an almost similar level. Also, in the OIP3 under a condition where a bandwidth is about 120 MHz and a gain is about 54 dB, it may be confirmed that a value of the RFIC 110 according to one or more embodiments and a value of the RFIC according to the comparative example are about 29.5 and about 29.2, respectively, and are at an almost similar level even in a situation where a bandwidth has varied.

Accordingly, in the RFIC 110 according to one or more embodiments, it may be confirmed that a dedicated capacitor individually disposed in each of a plurality of functional circuits is replaced with a shared capacitor while maintaining the same performance as that of the RFIC according to the comparative example, and thus, a chip area is reduced, and the manufacturing cost decreases. For example, an effect of reducing a chip area according to one or more embodiments may be more effective in a system where a bandwidth is narrow, and for example, WL TXABB may decrease by about 20% or more in chip area, and BT TXABB may decrease by about 50% or more in chip area.

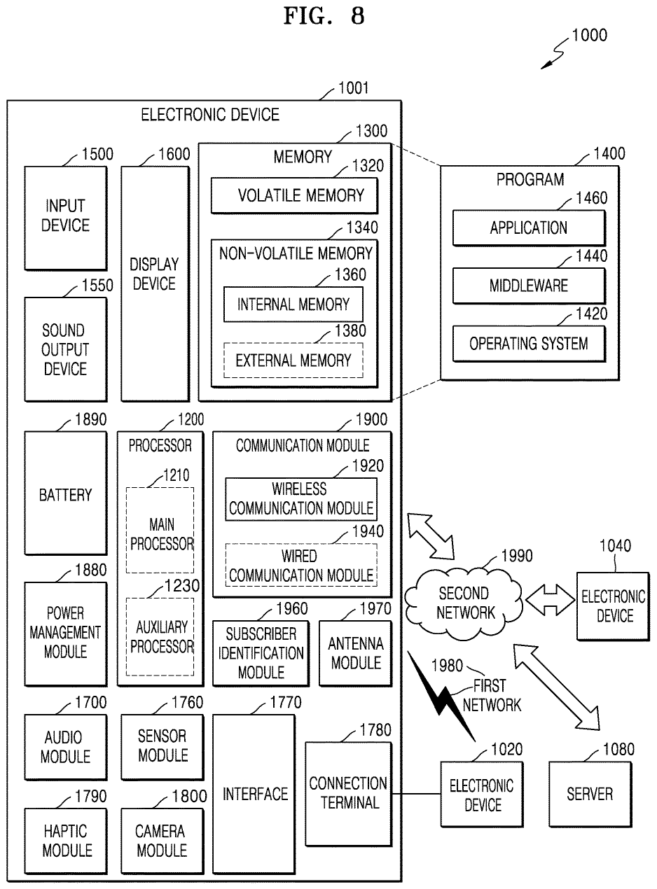

FIG. 8 is a block diagram of an electronic device according to one or more embodiments.

FIG. 8 is a block diagram of an electronic device 1001 in a network environment 1000, according to various embodiments. A communication module 1900 of FIG. 8 may correspond to the communication module 100 of FIGS. 1 to 7, and the electronic device 1001 of FIG. 8 may correspond to the wireless communication device 10 of FIGS. 1 to 7. The network environment 1000 of FIG. 8 may be a wireless communication system which operates based on a TDD scheme.

Referring to FIG. 8, in the network environment 1000, the electronic device 1001 may communicate with an electronic device 1020 through a first network 1980 (for example, a short-distance wireless communication network), or may communicate with an electronic device 1040 or a server 1080 through a second network 1990 (for example, a long-distance wireless communication network). According to one or more embodiments, the electronic device 1001 may communicate with the electronic device 1040 through the server 1080. According to one or more embodiments, the electronic device 1001 may include a processor 1200, a memory 1300, an input device 1500, a sound output device 1550, a display device 1600, an audio module 1700, a sensor module 1760, an interface 1770, a haptic module 1790, a camera module 1800, a power management module 1880, a battery 1890, a communication module 1900, a subscriber identification module 1960, or an antenna module 1970. In some embodiments, in the electronic device 1001, at least one (for example, the display device 1600 or the camera module 1800) of the elements, or one or more other elements may be added thereto. In some embodiments, some of the elements may be implemented as one integrated circuit. For example, the sensor module 1760 (for example, a fingerprint sensor, an iris sensor, or an illumination sensor) may be implemented with being embedded in the display device 1600 (for example, a display).

The processor 1200, for example, may execute software (for example, a program 1400) to control at least one other element (for example, a hardware or software element) of the electronic device 1001 connected to the processor 1200 and may perform various data processing or operations. According to one or more embodiments, in at least some of the various data processing or operations, the processor 1200 may load a command or data, received from another element (for example, the sensor module 1760 or the communication module 1900), into a volatile memory 1320, may process a command or data stored in the volatile memory 1320, and may store result data in a non-volatile memory 1340. According to one or more embodiments, the processor 1200 may include a main processor (for example, a CPU or an application processor) 1210 and an auxiliary processor 1230 (for example, a GPU, an image signal processor, a sensor hub processor, or a communication processor) capable of being executed independently of the main processor or together. Additionally or alternatively, the auxiliary processor 1230 may be set to use low power which is lower than power of the main processor 1210, or to be specific to a designated function. The auxiliary processor 1230 may be implemented separately from or a portion of the main processor 1210.

The auxiliary processor 1230, for example, may control at least one some of states or functions associated with (for example, the display device 1600, the sensor module 1760, or the communication module 1900) at least one of the elements of the electronic device 1001 instead of the main processor 1210 while the main processor 1210 is in an inactive (for example, sleep) state, or along with the main processor 1210 while the main processor 1210 is in an active (for example, application execution) state. According to one or more embodiments, the auxiliary processor 1230 (for example, an image signal processor or a communication processor) may be implemented as a portion of another element (for example, the camera module 1800 or the communication module 1900) functionally relevant thereto.

The processor 1200 according to one or more embodiments may control the wireless communication module 1920 so that an element (for example, a capacitor) is shared between circuits (for example, RF chains of an RFIC) of the wireless communication module 1920.

The memory 1300 may store various data used by at least one element (for example, the processor 1200 or the sensor module 1760) of the electronic device 1001. The data may include, for example, software (for example, the program 1400) and input data or output data corresponding to a command relevant thereto. The memory 300 may include the volatile memory 1320 or the non-volatile memory 1340. The non-volatile memory 1340 may include an internal memory 1360 and an external memory 1380.

The program 1400 may be stored as software in the memory 1300, and for example, may include an operating system 1420, middleware 1440, or an application 1460.

The input device 1500 may receive a command or data, which is to be used in the element (for example, the processor 1200) of the electronic device 1001, from the outside (for example, a user) of the electronic device 1001. The input device 1500 may include, for example, a microphone, a mouse, a keyboard, or a digital pen (for example, a stylus pen).

The sound output device 1550 may output a sound signal to the outside of the electronic device 1001. The sound output device 1550 may include, for example, a speaker or a receiver. The speaker may be used for the general purpose of multimedia reproduction or record reproduction, and the receiver may be used for receiving an incoming telephone call. According to one or more embodiments, the receiver may be implemented separated from or a portion of the speaker.

The display device 1600 may visually provide information to the outside (for example, a user) of the electronic device 1001. The display device 1600 may include, for example, a display, a hologram device, or a projector and a control circuit for controlling a corresponding device. According to one or more embodiments, the display device 1600 may include a touch circuit which is set to sense a touch or a sensor circuit (for example, a pressure sensor) which is set to measure the strength of a force generated by a touch.

The audio module 1700 may convert a sound into an electrical signal, or may convert an electrical signal into a sound. According to one or more embodiments, the audio module 1700 may obtain a sound through the input device 1500, or may output the sound through an external electronic device (for example, the electronic device 1020) (for example, a speaker or a headphone) directly or wirelessly connected to the sound output device 1550 or the electronic device 1001.

The sensor module 1760 may sense an operating state (for example, power or a temperature) of the electronic device 1001 or an external environment state (for example, a user state) and may generate a data value or an electrical signal corresponding to a sensed state. According to one or more embodiments, the sensor module 1760 may include, for example, a gesture sensor, a gyro sensor, an air pressure sensor, a magnetic sensor, an acceleration sensor, a grip sensor, a proximity sensor, a color sensor, an infrared (IR) sensor, a bio-physical sensor, a temperature sensor, a humidity sensor, or an illumination sensor.

The interface 1770 may support at least one designated protocols which may be used so that the electronic device 1001 is directly or wirelessly connected to the external electronic device (for example, the electronic device 1020). According to one or more embodiments, the interface 1770 may include, for example, a high definition multimedia interface (HDMI), a universal serial bus (USB) interface, a secure digital (SD) card interface, or an audio interface.

A connection terminal 1780 may include a connector which may physically connect the electronic device 1001 to the external electronic device (for example, the electronic device 1020). According to one or more embodiments, the connection terminal 1780 may include, for example, an HDMI connector, a USB connector, an SD card connector, or an audio connector (for example, a headphone connector).

The haptic module 1790 may convert an electrical signal into a mechanical stimulus (for example, a vibration or a motion) or an electrical stimulus. According to one or more embodiments, the haptic module 1790 may include, for example, a motor, a piezoelectric element, or an electrical stimulus device.

The camera module 1800 may capture a still image and a moving image. According to one or more embodiments, the camera module 1800 may include at least one lenses, image sensors, image signal processors, or flashes.

The power management module 1880 may manage power supplied to the electronic device 1001. According to one or more embodiments, for example, the power management module 1880 may be implemented as at least a portion of a power management integrated circuit (PMIC).

The battery 1890 may supply power to at least one element of the electronic device 1001. According to one or more embodiments, the battery 1890 may include, for example, a primary battery incapable of being recharged, a secondary battery capable of being charged, or a fuel battery.

The communication module 1900 may support communication performance through an established communication channel and the establishment of a wireless communication channel or a direct (for example, wired) communication channel between the electronic device 1001 and an external electronic device (for example, the electronic device 1020, the electronic device 1040, or the server 1080). The communication module 1900 may include at least one communication processor which operates independently of the processor 1200 (for example, an application processor) and supports wireless communication or direct (for example, wired) communication. According to one or more embodiments, the communication module 1900 may include a wireless communication module 1920 (for example, a cellular communication module, a short-distance wireless communication module, or a global navigation satellite system (GNSS) communication module) or a wired communication module 1940 (for example, a local area network (LAN) communication module or a power cable communication module). A corresponding communication module among the communication modules may communicate with the external electronic device 1040 through a first network 1980 (for example, a short-distance communication network such as Bluetooth, WiFi direct, or infrared data association (IrDA)) or a second network 1990 (for example, a long-distance communication network such as a cellular network, Internet, or a computer network (for example, LAN or WAN). Such several kinds of communication modules may be integrated into one element (for example, a single chip), or may be implemented with a plurality of elements (for example, a plurality of chips). The wireless communication module 1920 may check and authenticate the electronic device 1001 in a communication network such as the first network 1980 or the second network 1990 by using subscriber information (for example, International mobile subscriber identification (IMSI)) stored in the subscriber identification module 1960.

The wireless communication module 1920 according to one or more embodiments may include an RFIC (110 of FIG. 1) for short-distance wireless communication (for example, WiFi, Bluetooth, etc.). Here, at least one shared capacitor may be included in a second RF chain or a shared resource circuit (for example, 400 of FIG. 4).

An RFIC according to one or more embodiments may include a first RF chain and a second RF chain which differs from the first RF chain, and a target circuit included in the first RF chain may be selectively connected to at least one shared capacitor included in the second RF chain by using a plurality of switch elements.

The RFIC according to one or more embodiments may include a first RF chain and a second RF chain which differs from the first RF chain, and a target circuit included in the first RF chain may be selectively connected to at least one shared capacitor included in a shared resource circuit (for example, 400 of FIG. 4) by using a plurality of switch elements.

The RFIC according to one or more embodiments may further include a capacitance controller. In response to receiving a sharing request of the target circuit, the capacitance controller may determine a shared capacitance requested by a target circuit, may selectively combine at least one shared capacitors to form a shared capacitance, and may connect combined at least one shared capacitor to the target circuit.

The capacitance controller according to one or more embodiments may determine a shared capacitance requested by the target circuit, may generate a control signal to form at least one shared capacitor, based on the shared capacitance, and may transmit the control signal to a plurality of switch elements to connect the target circuit to the at least one shared capacitor. In this case, the capacitance controller may select a capacitor, having a capacitance which is greater than or equal to the shared capacitance, from among a plurality of capacitors included in the second RF chain to form at least one shared capacitor, or may selectively combine the plurality of capacitors included in the second RF chain to form at least one shared capacitor having a capacitance which is greater than or equal to the shared capacitance.

The RFIC according to one or more embodiments may time-divisionally operate in the transmit mode and the receive mode, based on a TDD scheme.

The first RF chain and the second RF chain according to one or more embodiments may be RF chains which independently operate without sharing the same time resource, based on a TDD scheme.

When the first RF chain according to one or more embodiments is a transmission RF chain, and the second RF chain is a reception RF chain, the target circuit may be at least one of functional circuits (for example, a DAC, a TX ABB, a mixer, a PA, and a combination thereof) included in the second RF chain (i.e., the reception RF chain).

When the first RF chain according to one or more embodiments is the reception RF chain, and the second RF chain is the transmission RF chain. the target circuit may be at least one of functional circuits (for example, an ADC, an RX ABB, a mixer, an LNA, and a combination thereof) included in the second RF chain (i.e., the transmission RF chain).

At least one shared capacitor according to one or more embodiments may be a capacitor included in each circuit included in the second RF chain, Alternatively, at least one shared capacitor according to one or more embodiments may be a capacitor included in a shared resource circuit (for example, 400 of FIG. 4) formed in a region separated from the first RF chain and the second RF chain, in the RFIC.

An antenna module 1970 may transmit or receive a signal or power to or from the outside (for example, an external electronic device). According to one or more embodiments, the antenna module 1970 may include one antenna which includes a conductor formed on a substrate (for example, a printed circuit board (PCB)) or a radiator including a conductive pattern. According to one or more embodiments, the antenna module 1970 may include a plurality of antennas. In this case, for example, at least one antenna suitable for a communication scheme used in a communication network such as the first network 1980 or the second network 1990 may be selected from among a plurality of antennas by the communication module 1900. The signal or the power may be transmitted or received between the communication module 1900 and an external electronic device through the selected at least one antenna. According to some embodiments, in addition to the radiator, another part (for example, an RFIC) may be additionally formed as a portion of the antenna module 1970.

The antenna module 1970 according to one or more embodiments may time-divisionally transmit or receive a transmission signal and a reception signal, based a TDD scheme.

At least some of the elements may be connected to each other and may exchange a signal (for example, a command or data) therebetween through a communication scheme (for example, a bus, a general purpose input and output (GPIO), a serial peripheral interface (SPI), or a mobile industry processor interface (MIPI)).

According to one or more embodiments, the command or the data may be transmitted or received between the electronic device 1001 and the external electronic device 1040 through the server 1080 connected to the second network 1990. Each of the external electronic devices 1020 and 1040 may be the same or different kind of device as or from the electronic device 1001. According to one or more embodiments, all or some of operations executed by the electronic device 1001 may be executed in at least one external electronic devices among the external electronic devices 1020, and 1040. For example, in a case where the electronic device 1001 has to automatically perform an arbitrary function or service or perform in response to a request from a user or another device, the electronic device 1001 may issue a request, to at least one external electronic devices, to perform at least a portion of a corresponding function or a corresponding service additionally or instead of autonomously executing the corresponding function or the corresponding service. The at least one external electronic devices which have received the request may execute at least a portion of the requested function or service or an additional function or service associated with the request and may transfer a result of the execution to the electronic device 1001. The electronic device 1001 may intactly or additionally process the result to provide as at least a portion of a response to the request. To this end, for example, cloud computing, distributed computing, or client-server computing technology may be used.

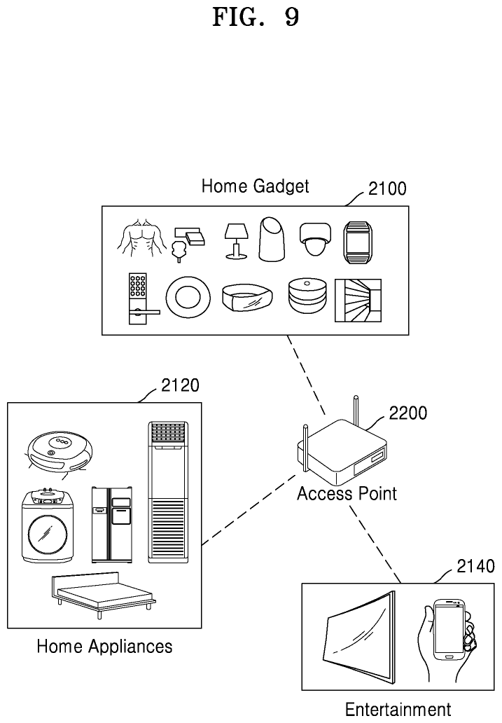

FIG. 9 is a diagram illustrating examples of electronic devices to which one or more embodiments is applied.

In FIG. 9, each of a home gadget 2100, home appliances 2120, and an entertainment device 2140 may be assumed to be an electronic device capable of a wireless communication connection, based on artificial intelligence (AI) and/or machine learning. Also, it may be assumed that an access point 2200 may perform a wireless communication connection by using communication technology based on AI and/or machine learning and at least one of electronic devices (for example, the home gadget 2100, the home appliances 2120, and the entertainment device 2140).

Referring to FIG. 9, each of electronic devices according to embodiments may include an RFIC (110 of FIG. 1) for short-distance wireless communication (for example, WiFi, Bluetooth, etc.). The RFIC according to one or more embodiments may time-divisionally operate in the transmit mode and the receive mode, based on a TDD scheme.

An RFIC according to one or more embodiments may include a plurality of RF chains for transmitting or receiving a wireless signal and at least one shared capacitor, and the at least one shared capacitor may be configured to be selectively connected to a first RF chain or a second RF chain, based on a sharing request of a target circuit included in the first RF chain among a plurality of RF chains. Here, at least one shared capacitor may be included in a second RF chain or a shared resource circuit (for example, 400 of FIG. 4).

An RFIC according to one or more embodiments may include a first RF chain and a second RF chain which differs from the first RF chain, and a target circuit included in the first RF chain may be selectively connected to at least one shared capacitor included in the second RF chain by using a plurality of switch elements.

An RFIC according to one or more embodiments may include a first RF chain and a second RF chain which differs from the first RF chain, and a target circuit included in the first RF chain may be selectively connected to at least one shared capacitor included in a shared resource circuit (for example, 400 of FIG. 4) by using a plurality of switch elements.

The capacitance controller according to one or more embodiments may determine a shared capacitance requested by the target circuit, may generate a control signal to form at least one shared capacitor, based on the shared capacitance, and may transmit the control signal to a plurality of switch elements to connect the target circuit to the at least one shared capacitor. In this case, the capacitance controller may select a capacitor, having a capacitance which is greater than or equal to the shared capacitance, from among a plurality of capacitors (included in the second RF chain or the shared resource circuit) to form at least one shared capacitor, or may selectively combine the plurality of capacitors (included in the second RF chain or the shared resource circuit) to form at least one shared capacitor having a capacitance which is greater than or equal to the shared capacitance.

The first RF chain and the second RF chain according to one or more embodiments may be RF chains which independently operate without sharing the same time resource, based on a TDD scheme.

Accordingly, in an RFIC, an operating method thereof, and an electronic device according to various embodiments, a capacitor may be shared between elements of the RFIC to decrease a circuit design area, and thus, a total chip area may be reduced while maintaining a high frequency characteristic and signal quality (for example, wireless communication performance), and the manufacturing cost may decrease.

In one or more embodiments, a radio frequency integrated circuit (RFIC) may include: a first radio frequency (RF) chain; and a second RF chain different from the first RF chain, wherein a target circuit in the first RF chain may be selectively connected to at least one shared capacitor in the second RF chain through a plurality of switch elements.

The RFIC may include a capacitance controller may be configured to, based on a capacitor sharing request received from the target circuit, control a connection of the target circuit to the at least one shared capacitor.

The target circuit may be configured to transmit the capacitor sharing request to the capacitance controller according to an operation mode of the first RF chain.

The capacitance controller may be further configured to: determine a shared capacitance requested by the target circuit; generate a control signal to form the at least one shared capacitor, based on the shared capacitance; and transmit the control signal to the plurality of switch elements to connect the target circuit to the at least one shared capacitor.

The capacitance controller may be further configured to: select a capacitor, having a capacitance greater than or equal to the shared capacitance, from among a plurality of capacitors included in the second RF chain, to form the at least one shared capacitor; or selectively combine the plurality of capacitors included in the second RF chain, to form the at least one shared capacitor having the capacitance greater than or equal to the shared capacitance.

The RFIC may be configured to time-divisionally operate in a transmit mode and a receive mode, based on a time division duplex (TDD) scheme.

The first RF chain may be a transmission RF chain, the second RF chain may be a reception RF chain, and the target circuit may include at least one of a digital-to-analog converter (DAC), a transmit analog baseband (TX ABB), a mixer, a power amplifier (PA), and a combination thereof.

The first RF chain may be a reception RF chain, the second RF chain may be a transmission RF chain, and the target circuit may include at least one of an analog-to-digital converter (ADC), a receive analog baseband (RX ABB), a mixer, a low noise amplifier (LNA), and a combination thereof.

The first RF chain and the second RF chain may be configured to independently operate without sharing a same time resource, based on a time division duplex (TDD) scheme.

In one or more embodiments, there is provided an operating method of a radio frequency integrated circuit (RFIC) including a first radio frequency (RF) chain and a second RF chain. The operating method may include: receiving a capacitor sharing request from a target circuit of the first RF chain; determining a shared capacitance requested by the target circuit; generating a control signal to form at least one shared capacitor, based on the shared capacitance; and connecting the target circuit to the at least one shared capacitor, based on the control signal.

The operating method may include: selecting a capacitor, having a capacitance greater than or equal to the shared capacitance, from among a plurality of capacitors included in the second RF chain, to form the at least one shared capacitor; or selectively combining the plurality of capacitors included in the second RF chain, to form the at least one shared capacitor having the capacitance greater than or equal to the shared capacitance.

The operating method may include: time-divisionally operating the RFIC in a transmit mode and a receive mode, based on a time division duplex (TDD) scheme.

The first RF chain may be a transmission RF chain, the second RF chain may be a reception RF chain, and the target circuit may include at least one of a digital-to-analog converter (DAC), a transmit analog baseband (TX ABB), a mixer, a power amplifier (PA), and a combination thereof.

The first RF chain may be a reception RF chain, the second RF chain may be a transmission RF chain, and the target circuit may include at least one of an analog-to-digital converter (ADC), a receive analog baseband (RX ABB), a mixer, a low noise amplifier (LNA), and a combination thereof.

The operating method may include: independently operating the first RF chain and the second RF chain without sharing a same time resource, based on a time division duplex (TDD) scheme.

In one or more embodiments, an electronic device may include: at least one processor; a memory; and a wireless communication module including a radio frequency integrated circuit (RFIC), wherein the RFIC may include: a first radio frequency (RF) chain, including a target circuit; a second radio frequency (RF) chain, wherein the second RF chain may be different from the first RF chain; at least one shared capacitor included in the second RF chain, a plurality of switch elements configured to selectively connect the target circuit in the first RF chain to the at least one shared capacitor in the second RF chain; and a capacitance controller coupled to the plurality of switch elements, the capacitance controller configured to: receive a capacitor sharing request from the target circuit, determine a required shared capacitance based on the capacitor sharing request, generate a control signal to selectively connect the target circuit to the at least one shared capacitor based on the required shared capacitance, and transmit the control signal to the plurality of switch elements to configure an electrical connection between the target circuit and the at least one shared capacitor.

The first RF chain may include a transmission analog baseband (TX ABB) circuit, and the second RF chain may include a reception analog baseband (RX ABB) circuit. The capacitance controller may be further configured to: based on the capacitor sharing request from the TX ABB circuit of a first RF chain WL0, selectively combine a plurality of capacitors in the RX ABB circuit of a second RF chain WL1 to form a first shared capacitor, and connect the TX ABB circuit of the first RF chain WL0 to the first shared capacitor, based on a time-division duplex (TDD) scheme in which the TX ABB circuit of the first RF chain WL0 and the RX ABB circuit of the second RF chain WL1 independently operate in different time resources.

The first RF chain may include a reception analog baseband (RX ABB) circuit, and the second RF chain may include a transmission analog baseband (TX ABB) circuit. The capacitance controller may be further configured to: based on the capacitor sharing request from the RX ABB circuit of a first RF chain WL0, selectively combine a plurality of capacitors in the TX ABB circuit of a second RF chain WL1 to form a second shared capacitor, and connect the RX ABB circuit of first RF chain WL0 to the second shared capacitor, based on a TDD scheme in which the RX ABB circuit of the first RF chain WL0 and the TX ABB circuit of the second RF chain WL1 independently operate in different time resources.

The first RF chain and the second RF chain may be configured to independently operate without sharing a same time resource, based on a time division duplex (TDD) scheme.

The at least one shared capacitor may include a capacitor included in each of circuits included in the second RF chain, or may include a capacitor included in a shared resource circuit formed in a region separated from the first RF chain and the second RF chain, in the RFIC.

Hereinabove, exemplary embodiments have been described in the drawings and the specification. Embodiments have been described by using the terms described herein, but this has been merely used for describing the disclosure and has not been used for limiting a meaning or limiting the scope of the disclosure defined in the following claims. Therefore, it may be understood by those of ordinary skill in the art that various modifications and other equivalent embodiments may be implemented from the disclosure. Accordingly, the spirit and scope of the disclosure may be defined based on the spirit and scope of the following claims.

While the disclosure has been particularly shown and described with reference to embodiments thereof, it will be understood that various changes in form and details may be made therein without departing from the spirit and scope of the following claims.

What is claimed is:

1. A radio frequency integrated circuit (RFIC) comprising:
a first radio frequency (RF) chain; and
a second RF chain different from the first RF chain,
wherein a target circuit in the first RF chain is selectively connected to at least one shared capacitor in the second RF chain through a plurality of switch elements.

2. The RFIC of claim 1, further comprising a capacitance controller is configured to, based on a capacitor sharing request received from the target circuit, control a connection of the target circuit to the at least one shared capacitor.

3. The RFIC of claim 2, wherein the target circuit is configured to transmit the capacitor sharing request to the capacitance controller according to an operation mode of the first RF chain.

4. The RFIC of claim 2, wherein the capacitance controller is further configured to:
determine a shared capacitance requested by the target circuit;
generate a control signal to form the at least one shared capacitor, based on the shared capacitance; and
transmit the control signal to the plurality of switch elements to connect the target circuit to the at least one shared capacitor.

5. The RFIC of claim 4, wherein the capacitance controller is further configured to:
select a capacitor, having a capacitance greater than or equal to the shared capacitance, from among a plurality of capacitors included in the second RF chain, to form the at least one shared capacitor; or
selectively combine the plurality of capacitors included in the second RF chain, to form the at least one shared capacitor having the capacitance greater than or equal to the shared capacitance.

6. The RFIC of claim 1, wherein the RFIC is configured to time-divisionally operate in a transmit mode and a receive mode, based on a time division duplex (TDD) scheme.

7. The RFIC of claim 1, wherein the first RF chain is a transmission RF chain,
the second RF chain is a reception RF chain, and
the target circuit comprises at least one of a digital-to-analog converter (DAC), a transmit analog baseband (TX ABB), a mixer, a power amplifier (PA), and a combination thereof.

8. The RFIC of claim 1, wherein the first RF chain is a reception RF chain,
the second RF chain is a transmission RF chain, and
the target circuit comprises at least one of an analog-to-digital converter (ADC), a receive analog baseband (RX ABB), a mixer, a low noise amplifier (LNA), and a combination thereof.

9. The RFIC of claim 1, wherein the first RF chain and the second RF chain are configured to independently operate without sharing a same time resource, based on a time division duplex (TDD) scheme.

10. An operating method of a radio frequency integrated circuit (RFIC) including a first radio frequency (RF) chain and a second RF chain, the operating method comprising:
receiving a capacitor sharing request from a target circuit of the first RF chain;
determining a shared capacitance requested by the target circuit;
generating a control signal to form at least one shared capacitor, based on the shared capacitance; and
connecting the target circuit to the at least one shared capacitor, based on the control signal.

11. The operating method of claim 10, further comprising:
selecting a capacitor, having a capacitance greater than or equal to the shared capacitance, from among a plurality of capacitors included in the second RF chain, to form the at least one shared capacitor; or
selectively combining the plurality of capacitors included in the second RF chain, to form the at least one shared capacitor having the capacitance greater than or equal to the shared capacitance.

12. The operating method of claim 10, further comprising:
time-divisionally operating the RFIC in a transmit mode and a receive mode, based on a time division duplex (TDD) scheme.

13. The operating method of claim 10, wherein the first RF chain is a transmission RF chain,
the second RF chain is a reception RF chain, and
the target circuit comprises at least one of a digital-to-analog converter (DAC), a transmit analog baseband (TX ABB), a mixer, a power amplifier (PA), and a combination thereof.

14. The operating method of claim 10, wherein the first RF chain is a reception RF chain,
the second RF chain is a transmission RF chain, and
the target circuit comprises at least one of an analog-to-digital converter (ADC), a receive analog baseband (RX ABB), a mixer, a low noise amplifier (LNA), and a combination thereof.

15. The operating method of claim 10, further comprising:
independently operating the first RF chain and the second RF chain without sharing a same time resource, based on a time division duplex (TDD) scheme.

16. An electronic device comprising:
at least one processor;
a memory; and
a wireless communication module including a radio frequency integrated circuit (RFIC),
wherein the RFIC comprises:
a first radio frequency (RF) chain, including a target circuit;
a second radio frequency (RF) chain, wherein the second RF chain is different from the first RF chain;
at least one shared capacitor included in the second RF chain;
a plurality of switch elements configured to selectively connect the target circuit in the first RF chain to the at least one shared capacitor in the second RF chain; and
a capacitance controller coupled to the plurality of switch elements, the capacitance controller configured to:
receive a capacitor sharing request from the target circuit,
determine a required shared capacitance based on the capacitor sharing request,
generate a control signal to selectively connect the target circuit to the at least one shared capacitor based on the required shared capacitance, and
transmit the control signal to the plurality of switch elements to configure an electrical connection between the target circuit and the at least one shared capacitor.

17. The electronic device of claim 16, wherein the first RF chain comprises a transmission analog baseband (TX ABB) circuit, and the second RF chain comprises a reception analog baseband (RX ABB) circuit, and
wherein the capacitance controller is further configured to:
based on the capacitor sharing request from the TX ABB circuit of a first RF chain WL0, selectively combine a plurality of capacitors in the RX ABB circuit of a second RF chain WL1 to form a first shared capacitor, and
connect the TX ABB circuit of the first RF chain WL0 to the first shared capacitor, based on a time-division duplex (TDD) scheme in which the TX ABB circuit of the first RF chain WL0 and the RX ABB circuit of the second RF chain WL1 independently operate in different time resources.

18. The electronic device of claim 16, wherein the first RF chain comprises a reception analog baseband (RX ABB) circuit, and the second RF chain comprises a transmission analog baseband (TX ABB) circuit, and
wherein the capacitance controller is further configured to:
based on the capacitor sharing request from the RX ABB circuit of a first RF chain WL0, selectively combine a plurality of capacitors in the TX ABB circuit of a second RF chain WL1 to form a second shared capacitor, and
connect the RX ABB circuit of first RF chain WL0 to the second shared capacitor, based on a TDD scheme in which the RX ABB circuit of the first RF chain WL0 and the TX ABB circuit of the second RF chain WL1 independently operate in different time resources.

19. The electronic device of claim 16, wherein the first RF chain and the second RF chain are configured to independently operate without sharing a same time resource, based on a time division duplex (TDD) scheme.

20. The electronic device of claim 16, wherein the at least one shared capacitor comprises a capacitor included in each of circuits included in the second RF chain, or comprises a capacitor included in a shared resource circuit formed in a region separated from the first RF chain and the second RF chain, in the RFIC.
